(19) United States
(12) Patent Application Publication
(10) Pub. No.: US 2012/0054984 A1
(43) Pub. Date: Mar. 8, 2012

(54) AIR TOOL HANDLE

(75) Inventors: YUNG-YUNG SUN, TAICHUNG COUNTY 412 (TW); CHUAN-CHING CHENG, TAICHUNG CITY 406 (TW)

(73) Assignee: STORM PNEUMTIC TOOL CO., LTD., TAICHUNG COUNTY (TW)

(21) Appl. No.: 12/876,429

(22) Filed: Sep. 7, 2010

(51) Int. Cl. B25G 1/00

(52) U.S. Cl. 16/110.1

(57) ABSTRACT

An air tool handle includes a first bushing and a second bushing prepared by different molds as two independent objects. The first bushing and the second bushing have a first hollow part and a second hollow part, respectively, that are in communication. The first bushing has several through parts and concave areas. The second bushing has several thin parts complementary to the concave areas and several thick parts connected with the thin parts and filling the through parts outward. The first bushing and the second bushing are combined along the same axial line. The first hollow part and the second hollow part accommodate the first body of an air tool or hand tool.

### BACKGROUND OF THE INVENTION

1. Field of Invention

The invention relates to an air tool handle and, in particular, to a handle structure for an air tool.

2. Related Art

Conventionally, the gel bushing of an air tool handle is mostly prepared by injection molding. When there is only a monotonic color, it has the disadvantage of a boring appearance. To have a better sale, most of them have two or more colors. In this case, two steps of injection molding are required in the manufacturing process. One way is to use two molding machines for the two steps of injections, respectively. In particular, the second injection molding is done while the temperature from the first injection is still high. This involves a lower cost, but has some problem in precision. Another way is to use a single molding machine for the two steps of injection molding. However, this kind of machines is more expensive and thus increases the fabricating cost.

Using either a single molding machine or two is likely to generate the following problem. The handle gel bushing is mounted on a tool body. The thickness of the gel bushing is not very thick, and some parts are even very thin. During the second step of injection molding, if the injection passage is narrow and long, the mobility of injected material becomes too low. In addition, the temperature is lower so that empty parts form in the filling material. To overcome this problem, one often increases the injection pressure. Nonetheless, this usually results in overflowing and rough edge problems. Therefore, it is not so easy to control an appropriate pressure in the above-mentioned injection molding.

If the structure is more complicated, smaller in area, and more precise, the above-mentioned problem becomes even more serious. The mold region where the filling raw material flows through may be wider or narrower, a fixed injection pressure cannot apply to all different regions for a good yield control. This is why it is difficult to have perfect quality in the prior art. Due to the same reason, the formation of three-dimensional patterns and words is not well.

As shown in FIGS. 13 and 14, a conventional tool handle has two letters ‘AA’ 81 and some other pattern. During the second molding, such thin and long parts 811, 82 are likely to be inhomogeneous in thickness. Or there may be the problem of material overflow 83 due to large pressure or the problem of small cracks 84 due to insufficient pressure.

Therefore, the prior art has various drawbacks mentioned above. This means a lower yield and/or higher production cost. To avoid such problems, most manufacturers adopt simple or planar patterns and structures. It is therefore highly desirable to improve the manufacturing process.

### SUMMARY OF THE INVENTION

In view of the foregoing, an objective of the invention is to provide an air tool handle. The handle includes a first bushing and a second bushing prepared separately to be independent objects. That is, they are prepared by respectively molds. In this case, there is no problem of material overflow when the injection pressure increases. At the same time, it solves the problem of insufficient injection. The first bushing and the second bushing thus formed have almost perfect quality individually. By combining them, it is possible to obtain handle gel bushings at a high yield rate.

Another objective of the invention is to provide an air tool handle whose first bushing and second bushing are formed by respectively molds without the problems of material overflow and insufficient filling. Even for more complicated, narrow and long patterns and words or three-dimensional designs, one can also obtain good molding effects. Thus, the invention allows high freedom in designs. The high precision in molds can ensure perfect assembly quality.

To achieve the above-mentioned objectives, the invention includes: a flexible first bushing and a flexible second bushing. The inner and outer sides of the first bushing have a first inner surface and a first outer surface, respectively. The first bushing has a first hollow part surrounded by the first inner surface and opening on both ends. Several through parts go through the first inner and outer surfaces of the first bushing. Moreover, the first inner surface has several concave areas.

The second bushing is separately prepared to be an independent object and corresponds to the first bushing. They can be combined along the same axial line. The inner and outer sides of the second bushing have a second inner surface and a second outer surface, respectively. The second bushing has a second hollow part surrounded by the second inner surface and opening on both ends. The first and second hollow parts are in communication after the combination of the first bushing and the second bushing. The second outer surface has several thin parts complementary to the concave areas, and several thick parts connected with the thin parts. Each of the thick parts fills at least two places in the several through parts from inside outward. The thin parts are at least on the two opposite sides of the thick parts to stop at the first inner surface around the through parts.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional assembly view of the first embodiment;

FIG. 2 is a three-dimensional exploded view of the first embodiment;

FIG. 3 is a cross-sectional view of the first embodiment perpendicular to the axial direction;

FIG. 4 is a cross-sectional view of the first embodiment along the radial direction;

FIG. 5 is a three-dimensional assembly view of the second embodiment;

FIG. 6 is a three-dimensional exploded view of the second embodiment;

FIG. 7 is a cross-sectional view of the first embodiment along the axial direction;

FIG. 8 is a three-dimensional assembly view of the third embodiment;

FIG. 9 is a three-dimensional exploded view of the third embodiment;

FIG. 10 is a longitudinal cross-sectional view of the third embodiment;

FIG. 11 is a transverse cross-sectional view of the third embodiment;

FIG. 12 is a longitudinal cross-sectional view of the third embodiment from another perspective;

FIG. 13 is a schematic view of the gel bushing of a conventional air tool handle; and

FIG. 14 is a schematic view showing bad junctions in the gel bushing of a conventional air tool handle.

### DETAILED DESCRIPTION OF THE INVENTION

The present invention will be apparent from the following detailed description, which proceeds with reference to the accompanying drawings, wherein the same references relate to the same elements.

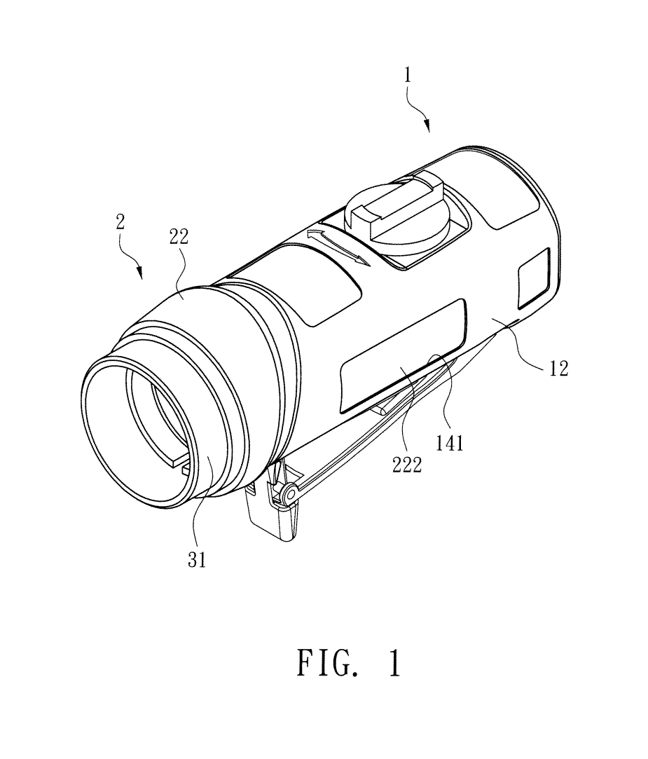

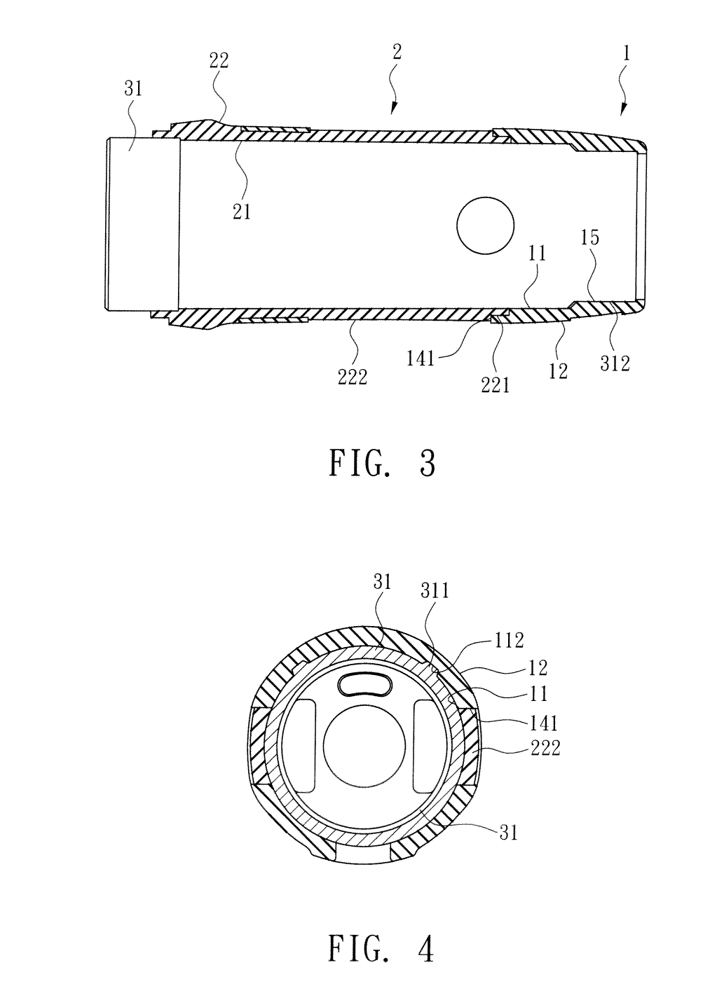

Please refer to FIGS. 1 to 4 for a first embodiment of the disclosed air tool handle. The air tool handle includes: a flexible first bushing 1 and a flexible second bushing 2.

The inner and outer sides of the first bushing 1 have a first inner surface 11 and a first outer surface 12. The first bushing 1 has a first hollow part 13 surrounded by the first inner surface 11 and opening on both ends. Several through parts 14 go through the region between the first inner and outer surfaces 11, 12 of the first bushing 1. The first inner surface 11 has several concave areas 111 for assembly positioning. In this embodiment, the concave areas 111 are slight recesses that extend continuously on the first inner surface. They are distributed along the radial and axial direction of the first inner surface 11.

The second bushing is separately prepared as an independent object from the first bushing 1. They can be combined along the same axial line. The inner and outer sides of the second bushing 2 have a second inner surface 21 and a second outer surface 22, respectively. The second bushing 2 has a second hollow part 23 in the second inner surface 22 and opening on both ends. The first and second hollow parts 13, 23 are in communication after the combination of the first bushing 1 and the second bushing 2. The second outer surface 22 has several thin parts 221 complementary to the concave parts 111, and several thick parts 222 connected with the thin parts 221. In this embodiment, each of the thick parts 222 fills at least two places of the through parts 14 from inside outward. Moreover, the thin parts 221 are at least on two opposite sides of the thick parts 222 to stop at the first inner surface 11 around the through parts 14. This prevents the thick parts 222 from escaping via the through parts 14.

Using the two thick parts 222 on opposite sides to fill the through parts 14 can produce an even engaging effect on both sides, rendering better assembly positioning between the first bushing 1 and the second bushing 2. In addition to helping the assembly between the first and second bushings 1, 2, the extra space of the through parts 14 can accommodate other elements, such as knob, pressing board, and internal control stick controlled by the pressing board (not shown). These elements are connected to a first body 31 inside the first and second bushings 1, 2, to be further assembled to form a complete air tool.

In the first embodiment, the surrounding of the second bushing 2 is basically a closed structure. The first and second hollow parts 13, 23 of the first and second bushings 1, 2 accommodate the first body 31. To prevent the first body 31 from rotating with respect to the first and second bushings 1, 2, at least one of the first and second inner surfaces 11, 21 has more than one first positioning groove 112. In this embodiment, as shown in FIG. 4, the first positioning grooves 112 are formed on the first inner surface 11 of the first bushing 1. A first positioning part 311 is formed on the first body 31 corresponding to each of the first positioning groove 112. Near its end portion, the first body 31 has a recess positioning area 312. The first bushing 1 has a protruding second positioning part 15 corresponding to the positioning area 312.

In the first embodiment, the through part 14 includes two first side holes 141 on both sides of the first bushing 1, respectively, a first through hole 142 at the top of the first bushing 1, and first and second connecting holes 143, 144 at the bottom of the first bushing 1. The left and right sides of the second bushing 2 extend two protruding wings 20 corresponding to the two first side holes 141. The thick parts 222 and part of the thin parts 221 are formed on the protruding winds 20. The surroundings of the first and second bushings 1, 2 have first and second profile sections 16, 24, respectively, that urge against each other along the axial direction. The first and second profile sections 15, 24 are formed roughly along the radial direction and according to the pattern on the mold.

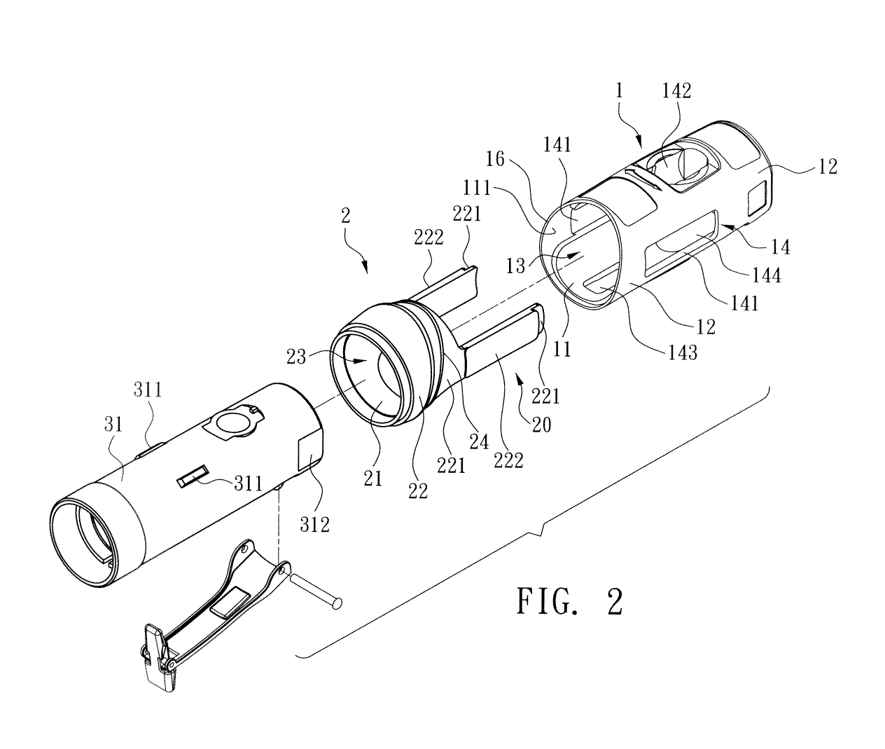

Please refer to FIG. 2. The first and second bushings 1, 2 are separately prepared by injection molding machines. That is, they are independent objects. Afterwards, the first bushing 1 and the second bushing 2 are combined according to FIGS. 1, 3, and 4.

Besides, the first bushing 1 and the second bushing 2 accommodate the first body 31, i.e., the metal cylindrical body of an air tool, in the first and second hollow parts 13, 23 thereof. The surrounding of the first body 31 is in touch with the first and second inner surfaces 11, 21. Moreover, the interior of the first body 31 has a passage (not shown) for air to flow through and for driving an air motor.

According to the invention, the first and second bushings are separately formed and then assembled. During injection molding, one does not need to worry about the problem of material overflow due to large pressure. One also does not need to worry about the problem of hollow parts or cracks due to insufficient injection pressure.

In summary, the invention can prevent the problems of material overflow or insufficient injection. The first bushing and the second bushing separately prepared according to the invention have almost perfect quality. They are then combined to form a handle gel bushing at an extremely high yield. At the same time, such a manufacturing method has better molding effects on more complicated, narrow and long, and three-dimensional patterns and text. The invention offers high freedom in designs. With the high precision of molds, it is possible to obtain perfect assembly quality.

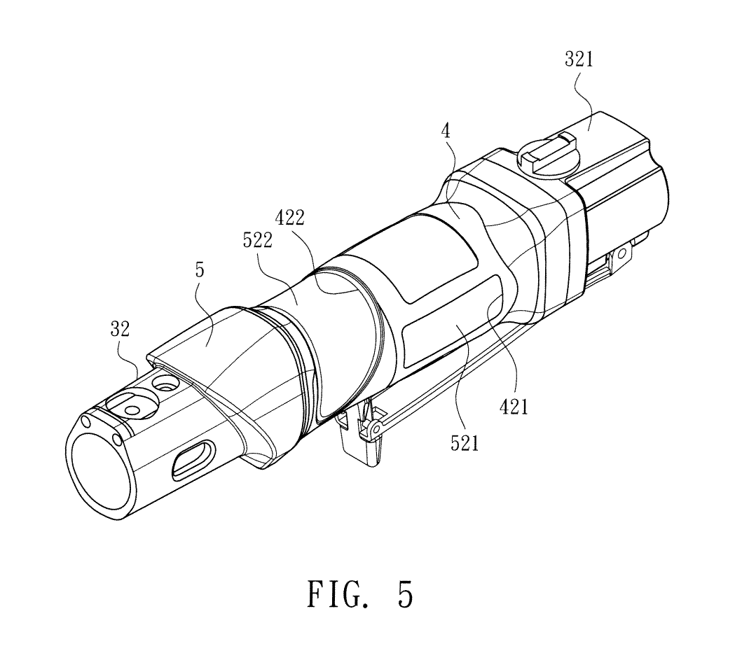

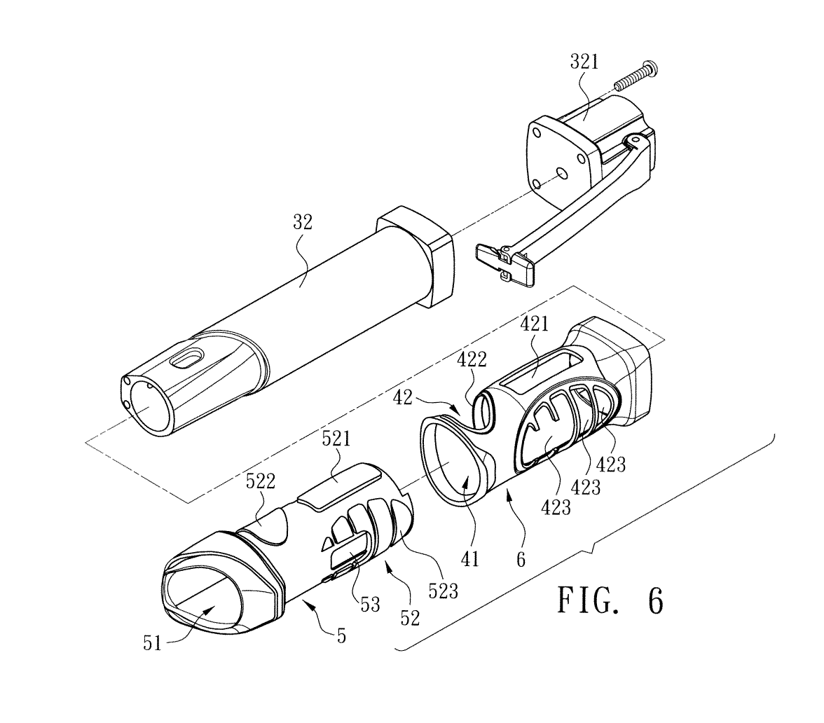

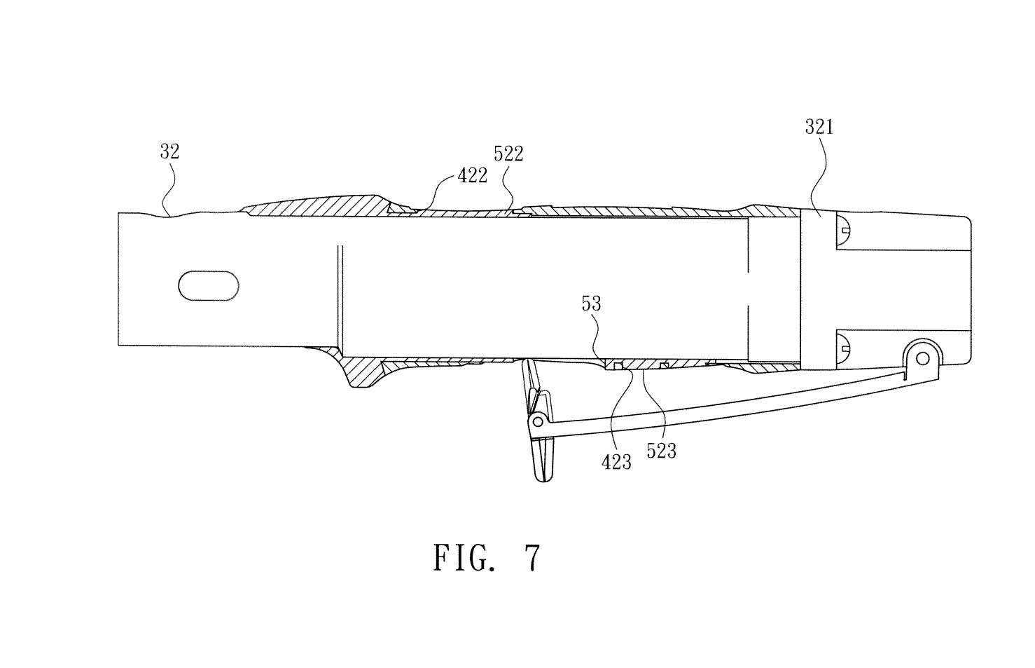

Of course, the invention has many other embodiments that have similar structures as the above-mentioned embodiment, with some minor variations in details. Please refer to FIGS. 5 to 7 for a second embodiment. The surrounding of the second bushing 4 is basically a closed structure. The first and second hollow parts 41, 52 of the first and second bushings 4, 5 accommodate a second body 32. The end portion of the second body 32 has a connecting component 321. The through parts 42 include a second side hole 431 on one side of the first bushing 4, a second through hole 422 at the top of the first bushing 4, and several third connecting holes 423 at the bottom of the first bushing 4. The third connecting holes 423 include several holes of different sizes. The thick parts 52 include a first part 521, a second part 522, and several third parts 523, corresponding to and filling the second side hole 421, the second through hole 422, and the third connecting holes 423. A fourth connecting hole 53 goes through the second bushing 5 corresponding to the third parts 523 of the third through holes 423. With a non-spherical shape on the other end portion of the second body 32, the interior does not rotate after the first and second bushings 4, 5 are combined.

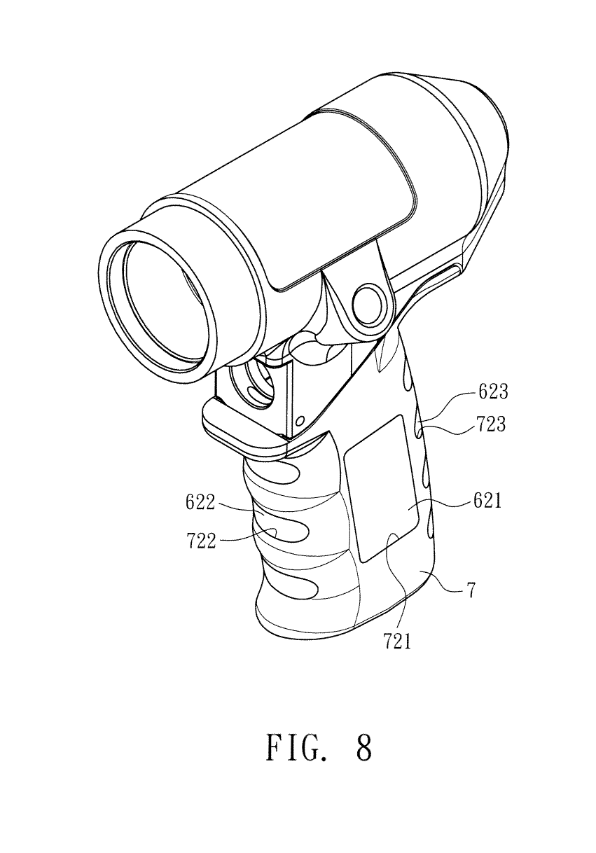

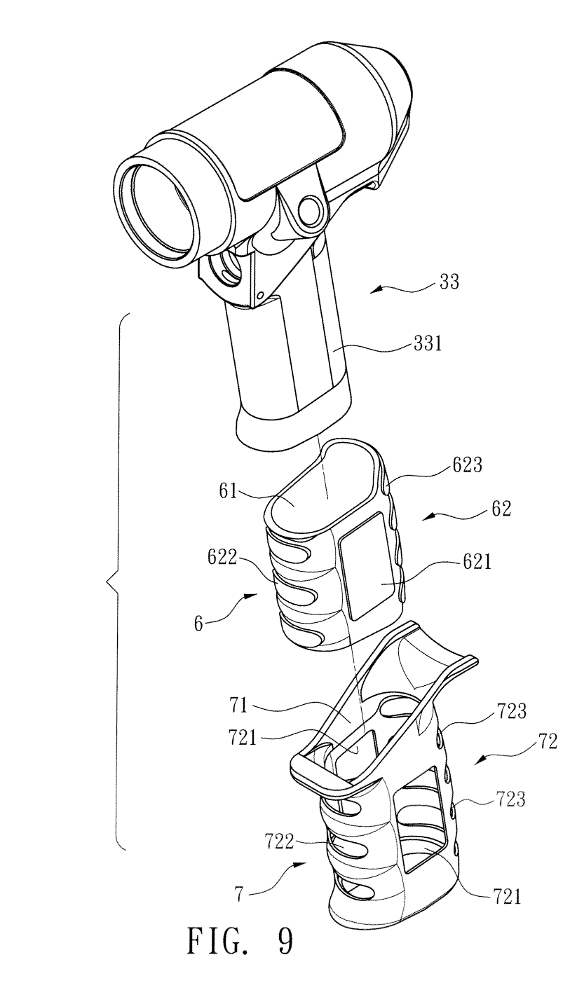

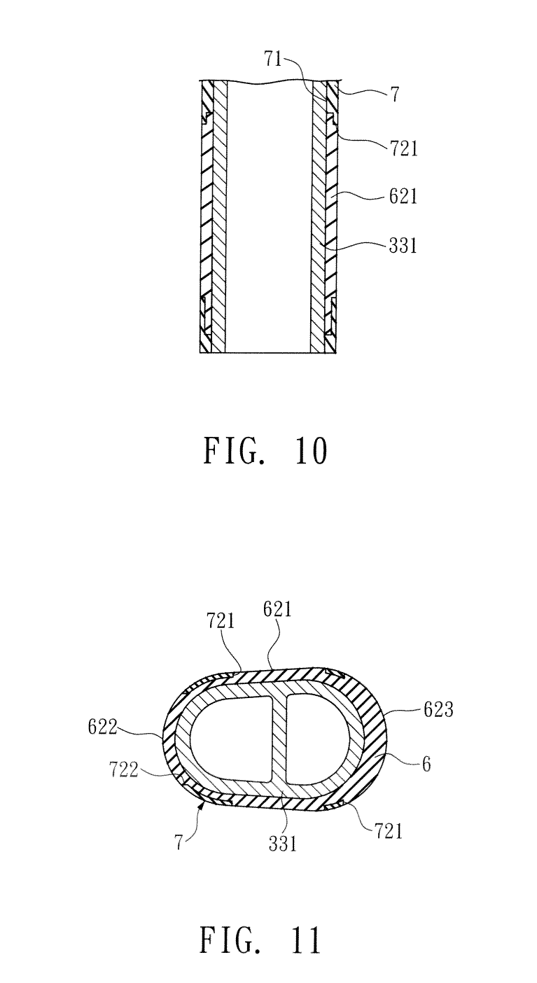

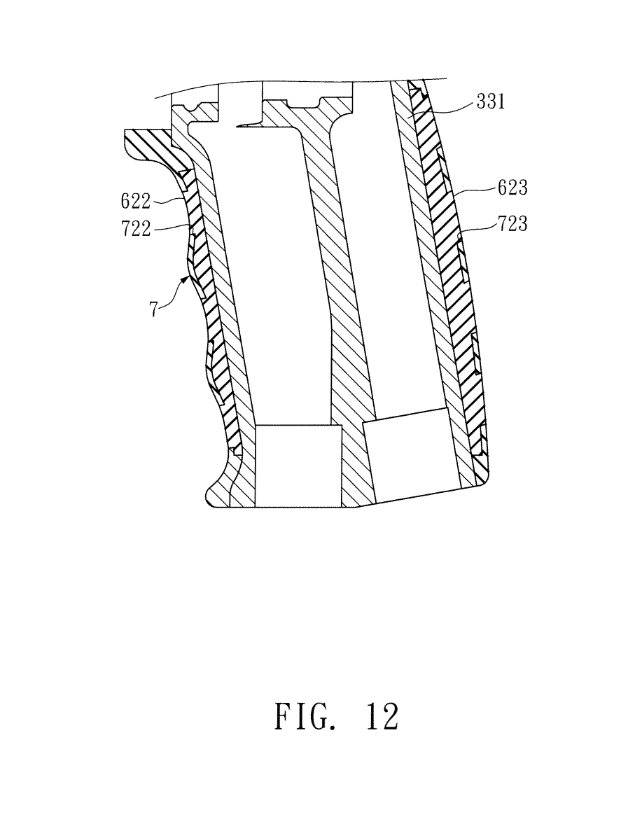

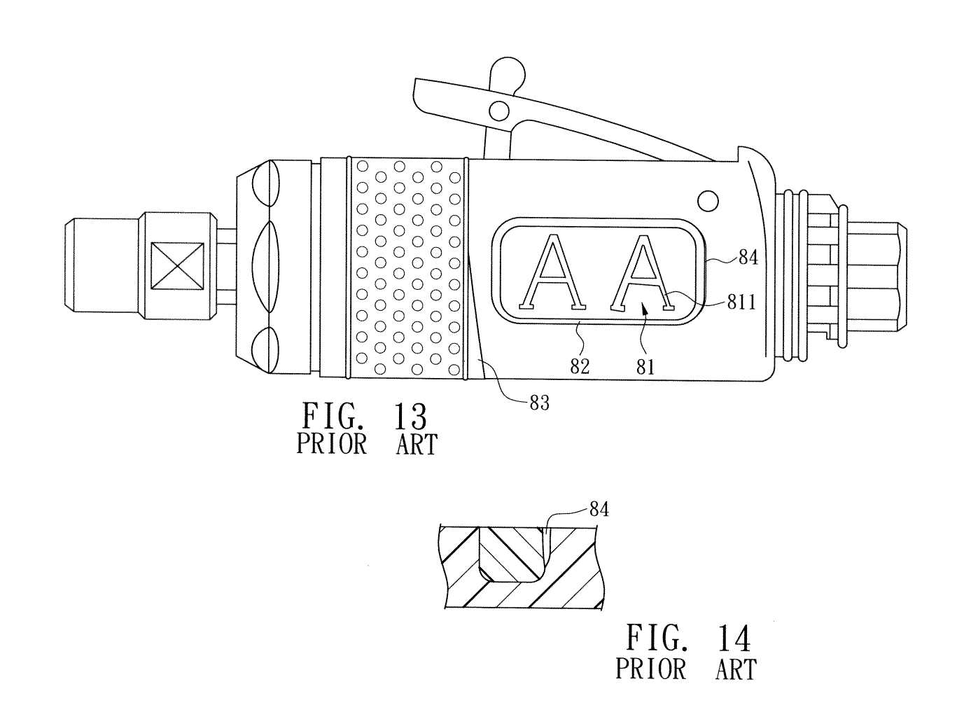

Please refer to FIGS. 8 to 12 for a third embodiment of the invention. The surrounding of the second bushing 6 is a closed structure and accommodated in the first bushing 7. A third body 3 is in the shape of a gun and inside the first and second hollow parts 71, 61 of the first and second bushings 7, 6, respectively. The handle 331 under the third body 33 is non-spherical. The first and second hollow parts 71, 61 have the structures corresponding to the handle 331 of the third body 33, thereby restricting the relative positions between them. The through parts 72 include two third side holes 721 on left and right sides of the first bushing 7, and several fourth side holes 722 and fifth side holes 723 on front and rear sides of the first bushing 7. The thick parts 62 include third parts 621, fourth parts 622, and fifth parts 623 to fill the third side holes 721, the fourth side holes 722, and the fifth side holes 723.

As described above, the first and second bushings in the second and third embodiments of the invention are also separately formed by injection. They are combined together afterwards. Therefore, they have the same advantages as the first embodiment.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. An air tool handle, comprising:
a flexible first bushing, which has a first inner surface and a first outer surface on whose inner and outer sides, respectively, a first hollow part surrounded by the first inner surface and opening on both ends, and a plurality of through parts between the first inner and outer surfaces, with a plurality of concave areas formed on the first inner surface;
a flexible second bushing separately prepared as an independent object from the first bushing and to be combined with the first bushing along an axial line, which has a second inner surface and a second outer surface on inner and outer sides, respectively, a second hollow part in the second inner surface and opening on both ends, a plurality of thin parts on the second outer surface complementary to the concave areas, and a plurality of thick parts connected with the thin parts;
wherein the first and second hollow parts are in communication after the first bushing and the second bushing are combined, each of the thick parts fills at least two of the through parts from inside outward, and the thin parts are at least on two opposite sides of the thick parts to stop the first inner surface around the through parts.

2. The air tool handle of claim 1, wherein the surrounding of the second bushing is a closed structure, the first and second hollow parts of the first and second bushings accommodate a first body, at least one of the first and second inner surfaces has more than one first positioning groove, and a first positioning part is formed on the first body corresponding to each of the first positioning grooves.

3. The air tool handle of claim 2, wherein the through parts include two first side holes on left and right sides of the first bushing, a first through hole at the top of the first bushing, two first and second connecting holes at the bottom of the first bushing, and two protruding wings corresponding to the two first side holes extended from the second bushing, with the thick parts and part of the thin parts formed on the protruding wings.

4. The air tool handle of claim 3, wherein the surroundings of the first and second bushings have respectively a first profile section and a second profile section that urge against each other.

5. The air tool handle of claim 1, wherein the surrounding of the second bushing is a closed structure, and the first and second hollow parts of the first and second bushings accommodate a second body.

6. The air tool handle of claim 5, wherein the through parts includes a second side hole on one side of the first bushing, a second through hole at the top of the first bushing, and a plurality of third connecting holes at the bottom of the first bushing, the thick parts fill the second side hole, the second through hole, and the third connecting holes, and a fourth connecting hole is formed on the thick parts of the second bushing corresponding to the third connecting holes.

7. The air tool handle of claim 1, wherein the surrounding of the second bushing is a closed structure that is accommodated in the first bushing, the first and second hollow parts of the first and second bushings accommodate a third body in a non-spherical structure, and the first and second hollow parts have structures corresponding to the third body in order to restrict the relative positions between the first and second hollow parts and the third body.

8. The air tool handle of claim 7, wherein the through parts include two third side holes on two opposite sides of the first bushing, a plurality of fourth side holes and fifth side holes on front and rear sides of the first bushing, and the thick parts fill the third side holes, the fourth sides, and the fifth side holes.
